(19) United States
(12) Patent Application Publication
(10) Pub. No.: US 2003/0005043 A1
(43) Pub. Date: Jan. 2, 2003

(54) Computer telephony speech system capable of detecting crash and being reset automatically and its method

(75) Inventor: Jyh-Shing Hsu, Taipei (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 09/956,884

(22) Filed: Sep. 21, 2001

(30) Foreign Application Priority Data
Jun. 27, 2001 (TW) 90115657

(51) Int. Cl. G06F 15/16

(52) U.S. Cl. 709/203

(57) ABSTRACT

A computer telephony speech system capable of detecting crash and being reset automatically includes a computer telephone speech server unit, and a detecting unit connected to the computer telephony speech server unit. When answering a call, the computer telephony speech server unit issues an active message for being sent to an internal reset module and to the detecting unit via a communication link. If the detecting unit receives no active message in a first predefined time period, a reset message is sent to the reset module for performing a reset operation. If the reset module does not receive any active message or reset message in a second predefined time period, a reset operation is performed automatically. The second predefined time period is larger than the first predefined time period.

### BACKGROUND OF THE INVENTION

1. Field of the Invention

The present invention relates to a computer telephony speech system, and, more particularly, to computer telephony speech system capable of detecting crash and being reset automatically and its method.

2. Description of Related Art

Currently, with the wide spread use of telephony systems, it is very popular to access information through a telephone. Therefore, many computer telephony speech systems are developed, for example, the auto telephone exchange system, weather inquiry system, hospital registering system and traffic inquiry system. Most of the systems provide multi-channel services. When more and more services are required by the users, the functions of the systems become more and more complex, and thus the loads of the systems are increased. Accordingly, the possibility in that the system becomes abnormal and is crashed is increased. Therefore, in order to provide a whole day service, the high reliability and high availability are required and become a major concern in designing a system.

There are many reasons that may cause the system to crash, which can be classified as a hardware problem and a software problem. In the hardware problem, other than the computer hardware, the telephone interface for providing speech functions may also cause the system to crash. However, in general, such a problem can only be dealt with by the hardware manufacturer, instead of the designer of the computer telephony speech system. For example, some telephony card manufacturers provide a hot-swapped telephony card. In a system with such a telephony card, if the telephony card is out of order, one can simply pull out the bad telephony card and insert a new card. The driver program will be automatically loaded into the system and be activated. As to the software problem, two kinds of problem can be classified. One is the problem in the computer telephony speech system, which is generally resulted from the improper process of the multi-threaded program. The other one is resulted from the error of the driver program of the telephony card. In general, this problem can not be solved by the system designer, and has to be reported to the hardware manufacturer. Therefore, the crash problem is inevitably existed in the computer telephony speech system due to the hardware and software problems.

Conventionally, when a crash-like problem is occurred in a telephony speech system, the system is manually and continuously detected whether the system is actually crashed. If it is detected that the system is indeed crashed, the system is restarted manually. Such a conventional method can not meet the actual requirement because tremendous labor and time are required. In U.S. Pat. No. 6,065,053 granted to Nouri, et al. for “A system for resetting a server”, a local area network or RS-232 interface is used to reset the computer system in the near end, and a modem is used to reset the computer system in the far end via a telephone network, thereby achieving the object of resetting a computer system. With such an arrangement, the system manager has to determine whether the system should be restarted through a far end or near end screen, and the modem is used only for connecting a far-end device to the system without providing a reset function. Therefore, it is unable to resolve the crash problem of the computer telephony speech system. Accordingly, it is desirable to provide a novel system and method to mitigate and/or obviate the aforementioned problems.

### SUMMARY OF THE INVENTION

The object of the present invention is to provide a computer telephony speech system to capable of detecting crash and being reset automatically and its method.

In accordance with one aspect of the present invention, the computer telephony speech system includes a computer telephony speech server unit and a detecting unit. In the computer telephony speech server unit, a telephone speech interface is provided for answering a call. A computer telephony speech module provides the telephone speech service, and, when the telephone speech interface answers a call, issues an active message. A reset module is provided for resetting the computer telephony speech system. A first communication interface is provided for connecting to the detecting unit. In the detecting unit, a second communication interface is corresponding to the first communication interface for connecting to the computer telephony speech server unit. A dial interface is provided for dialing and connecting to the computer telephony speech server unit. A detecting module is provided for receiving the active message through the first and second communication interfaces. If the detecting module dose not receive an active message in a first predefined time period, the detecting module issues a reset message to the reset module for performing a reset operation.

In accordance with another aspect of the present invention, there is provided a method for detecting crash and automatically resetting a computer telephony speech system. The computer telephony speech system includes a computer telephony speech server unit and a detecting unit for connecting to the computer telephony speech server unit. The computer telephony speech server unit has a reset module for performing a reset operation. In the method, the computer telephony speech server unit issues an active message for being sent to the detecting unit through a communication link when correctly answering a call. Then, if no active message is received in a first predefined time period, the detecting unit issues a reset message to the reset module of the computer telephony speech server unit for performing a reset operation.

Other objects, advantages, and novel features of the invention will become more apparent from the following detailed description when taken in conjunction with the accompanying drawings.

### BRIEF DESCRIPTION OF THE DRAWINGS

FIG. 1 shows a system structure of the computer telephony speech system capable of detecting crash and being reset automatically in accordance with the present invention.

FIG. 2 shows the control flowchart of the computer telephony speech server unit and the detecting unit of the system in accordance with the present invention.

FIG. 3 schematically illustrates the format of the active message.

FIG. 4 shows the curve concerning the use of an auto telephone exchange system and the channel number and time of a previous call.

FIG. 5 schematically illustrates the format of the reset message.

FIG. 6 shows a control flowchart of the reset module of the computer telephony speech server unit in accordance with the present invention.

### DETAILED DESCRIPTION OF THE PREFERRED EMBODIMENT

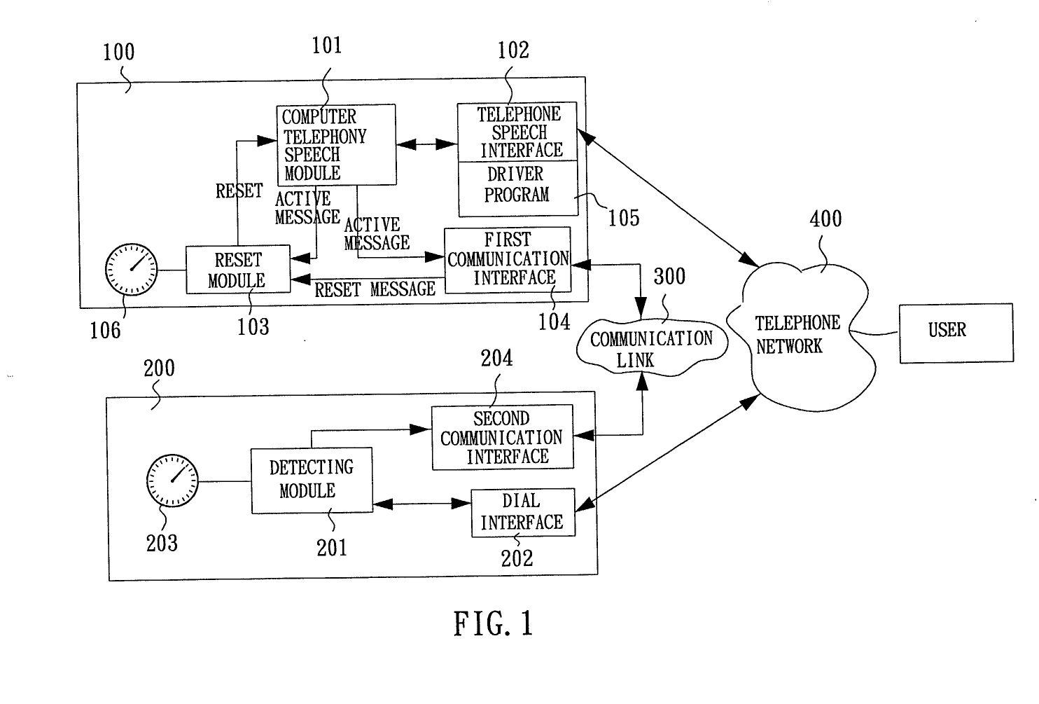

FIG. 1 shows the system structure of the computer telephony speech system capable of detecting crash and being reset automatically in accordance with the present invention, which includes a computer telephony speech server unit 100, and a detecting unit 200. The computer telephony speech server unit 100 can be a computer device, or the likes, for providing the computer telephony speech service. The computer telephony speech server unit 100 includes a computer telephony speech module 101 for providing telephone speech service, a telephone speech interface 102 for answering the calls from a telephone network 400, a reset module 103 and a first communication interface 104. The telephone speech interface 102 is installed with a driver program 105 for being called and executed by the computer telephony speech system. The first communication interface 104 is, for example, a network card or an RS232 interface for sending the status of the computer telephony speech system to the detecting unit 200 through a communication link 300. The reset module 103 is used to reset the computer telephony speech module 101 when the computer telephony speech system is crashed.

The detecting unit 200 can be implemented by a computer device, which includes a detecting module 201 for detecting whether the computer telephony speech server unit 100 has been crashed, a dial interface 202 capable of dialing and connecting to the computer telephony speech server unit 100 through a telephone network 400, and a second communication interface 204, such as a network card or an RS232 interface, which is corresponding to the first communication interface 104 of the computer telephony speech server unit 100 for receiving the status of the computer telephony speech server unit 100, and transferring, when a crash is detected, a reset signal to the reset module 103 of the computer telephony speech server unit 100 through the communication link 300. FIG. 4 is a display screen of a computer device implementing the detecting unit, which shows the status of the computer telephony speech server unit 100, such as the channel status, so that the user can be aware of the operation condition of the system.

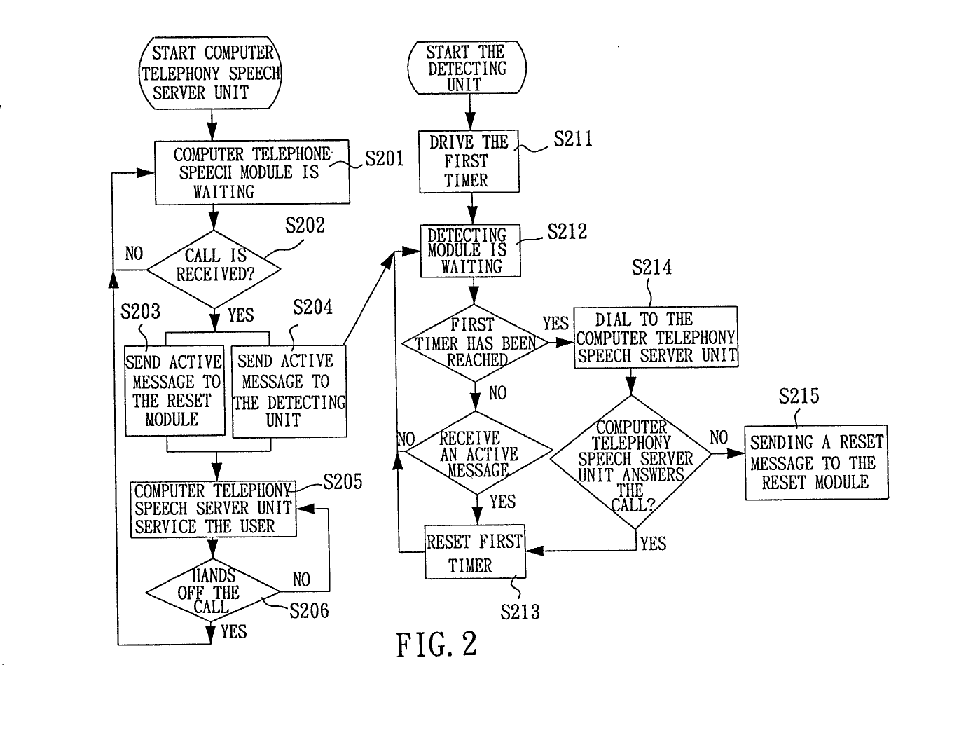

With the above computer telephony speech system, it is able to realize the function of detecting a crash and automatically resetting the system. Referring to FIGS. 1 and 2, the computer telephony speech server unit 100 is realized as an auto telephone exchange system for describing the operation flow of the method of the present invention. The auto telephone exchange system can answer a call from the user and then switch the call to other extension lines according to the name pronounced by the user. As shown in FIG. 2, after the computer telephony speech module 101 of the computer telephony speech server unit 100 is started and the system is in normal condition, the computer telephony speech module 101 is waiting for a call for providing an auto telephone exchange service (step S201). If a call is made by a user and the telephone speech interface 102 correctly answers the call (step S202), the computer telephony speech module 101 is driven to issue an active message. This active message is sent to the reset module 103 in the same computer device (step S203), and is also sent to the remote detecting unit 200 through the communication link 300 by the first communication interface 104 (step S204). Then, the computer telephony speech module 101 of the computer telephony speech server unit 100 is able to provide service to the user (step S205). When the user hands off the telephone (step S206), the process returns to step S201 to wait for a call.

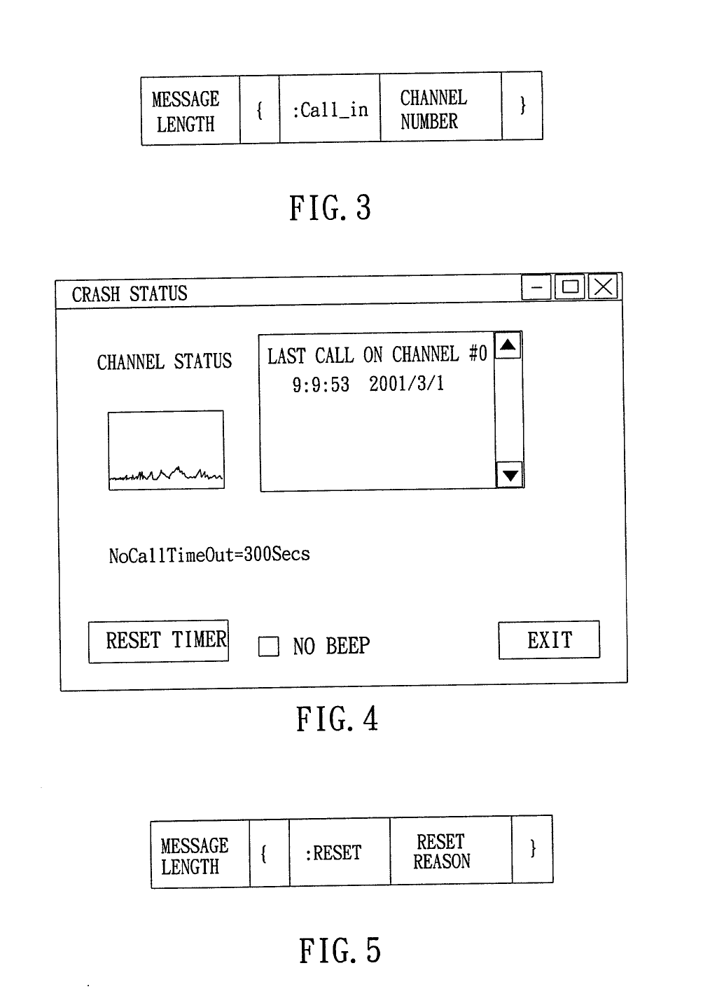

The aforementioned active message is transferred in a form of data frame, which has a format as illustrated in FIG. 3. Each data frame has the fields of message length and message content. The content is stored with a form of {KEY, VALUE}. For example, in the active messages, ‘:call_in’ is a KEY, and its VALUE is the channel number in the telephone speech interface 102.

With reference to FIGS. 2 and 1, after starting the detecting unit 200, a first timer 203 is driven for counting to a first predefined time period (step S211). The detecting module 201 is waiting for a message, i.e., the active message issued by step S204, from the computer telephony speech server unit 100 (step S212). If the detecting module 201 receives the active message through the second communication interface 204 before the first timer 203 has reached the first predefined time period, the detecting module 201 is aware of the active status of each channel of the auto telephone exchange system and that the auto telephone exchange system is now in a normal condition, and thus resetting the first timer (step S213). Meanwhile, the detecting unit 200 may perform a statistic analysis on the utilization of the auto telephone exchange system. As shown in FIG. 4, the analysis result is displayed on a screen by a curve, so that the system manager can conveniently know the condition of the auto telephone exchange system.

On the contrary, if the timer 203 has reached the first predefined time period but the detecting module 201 does not receive any active message, it indicates that the operation of the auto telephone exchange may be abnormal so that the auto telephone exchange can not receive incoming calls, and thus no active message can be transferred to the detecting unit 200. At this moment, the detecting unit 200 can directly transfer a reset message to the reset module 103 of the computer telephony speech server unit 100 for performing a reset operation. However, in order to assure that the computer telephony speech server unit 100 is indeed crashed, the detecting unit 200 automatically dials and connects to the computer telephony speech server unit 100 through the dial interface 202 for testing the condition of the system (step S214). If the auto telephone exchange system can answer the call, the computer telephony speech module 101 issues an active message to the detecting unit 200 as in the normal condition. After the detecting unit 200 receives this active message, it can determine that the computer telephony speech server unit 100 is in normal condition, and thus the first timer is reset to zero (step S213). Generally, this condition occurs when the auto telephone exchange system is not very busy, for example, in holiday. On the contrary, if the auto telephone exchange system can not answer the call, the detecting unit 200 knows that the auto telephone exchange system is crashed. Therefore, the detecting unit 200 issues a reset message to the reset module 103 of the computer telephony speech server unit 100 via the communication link (step S215). The format of the reset message is shown in FIG. 5. The content of the message is also stored with the form of {KEY, VALUE}. For example, a message having a KEY of ‘:reset’ and a VALUE of ‘noanswer’ represents that the reason for resetting is that the auto telephone exchange system can not answer a phone call.

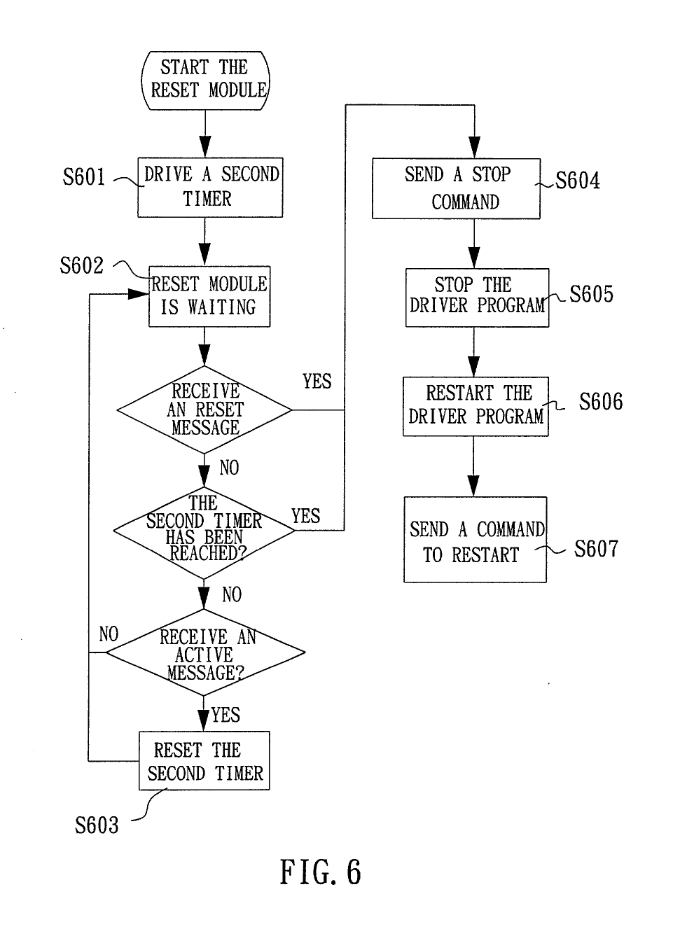

When receiving a reset message, the reset module 103 calls the operating system to directly terminate the execution of the operation system or restart the auto telephone exchange system. However, in order to avoid a condition that the detecting unit 200 can not transfer the reset message to the reset module 103 due to the breakdown of the communication link 300, when transferring the active message, the computer telephony speech server unit 100 also transfers the active message to the reset module 103, whereby the reset module 103 can determine whether it is necessary to perform a self-reset. With reference to FIG. 6, after the reset module 103 is started, a second timer 106 is driven for counting to a second predefined time period (step S601). The reset module 103 is waiting for a reset message from the detecting unit 200 or an active message from the computer telephony speech module 101 (step S602). If the reset module 103 receives the active message from the computer telephony speech module 101 while no reset message is received and before the second timer 106 reaches the second predefined time period, it can be determined that the computer telephony speech server unit 100 is in normal condition, and thus the second timer is reset to zero (step 603). Since the reset module 103 and the computer telephony speech module 101 are located at the same computer device, it is impossible to fail in receiving the active message due to the problem of the communication link 300.

On the contrary, if a reset message is received, or the second timer has reached the second predefined time period while no reset message is received, it can be determined that the computer telephony speech server unit 100 has been crashed. Possibly, the auto telephone exchange system is crashed due to the problem in the auto telephone exchange system itself or in a driver program. Therefore, the reset operation of the reset module 103 can be divided into two parts. The first part is to close the driver program 105 of the auto telephone exchange system and the telephone speech interface 102. The second part is to restart the driver program 105 and the auto telephony exchange system. As a result, as shown in FIG. 6, the reset module 103 first sends a stop command to terminate the auto telephone exchange system (step S604). Then, the driver program 105 of the telephone speech interface 102 is stopped (step S605). Next, the driver program 105 of the telephone speech interface 102 is restarted (step S606). Then, the auto telephone exchange system is restated (step S607), whereby the auto telephone exchange system is recovered to the normal condition.

In view of foregoing, it is known that the present invention is able to detect a crash by using the existed features of the computer telephony speech system. That is, if the computer telephony speech server unit is in normal condition, i.e., capable of answering a call and providing services, the system is known to be in an active status. Therefore, it is only necessary to transfer this active message to the detecting unit, and the detecting unit can know the operation condition of the computer telephony speech server unit. Besides, if no active message from the computer telephony speech server unit is received in the first predefined time period counted by the first timer, the detecting unit will automatically detects whether the computer telephony speech server unit is able to correctly answer a phone call by using a dial-in test through the dial interface, so as to determine whether it is necessary to restart the system. Therefore, it can be assured that the computer telephony speech server unit is restarted only when the system is actually crashed. In addition, if there is no active message or reset message received within the second predefined time period counted by the second timer, the computer telephony speech server unit can start a reset operation by itself. Therefore, it is able to avoid the condition that the detecting unit can not reset the system due to the breakdown of the external communication link. The first predefined time period must be smaller than the second predefined time period. Typically, the first predefined time period is very short, for example, five minutes. Therefore, when the system is crashed and if the communication link is not broken, the system will be reset automatically after five minutes. The second predefined time period is relatively large, for example 12 hours, for preventing the system from being erroneously reset. Therefore, when the system is crashed and the communication link is broken, the system can be reset automatically after 12 hours.

Although the present invention has been explained in relation to its preferred embodiment, it is to be understood that many other possible modifications and variations can be made without departing from the spirit and scope of the invention as hereinafter claimed.

What is claimed is:

1. A computer telephony speech system capable of detecting crash and being reset automatically, comprising:
a computer telephony speech server unit including:
a telephone speech interface for answering a call;
a computer telephony speech module for providing telephone speech service, and, when the telephone speech interface answers a call, issuing an active message;
a reset module for resetting the computer telephony speech system; and
a first communication interface; and
a detecting unit including:
a second communication interface corresponding to the first communication interface for connecting the detecting unit to the computer telephony speech server unit;
a dial interface for dialing and connecting to the computer telephony speech server unit; and
a detecting module for receiving the active message through the first and second communication interfaces, wherein, if the detecting module dose not receive an active message in a first predefined time period, the detecting module issues a reset message to the reset module for performing a reset operation.

2. The system as claimed in claim 1, wherein, when the detecting module dose not receive the active message in the first predefined time period, the dial interface dials a call to the computer telephony speech server unit, and if the computer telephony speech server unit can not answer the call, the detecting unit sends a reset message to the reset module through the first and second communication interfaces for performing a reset operation.

3. The system as claimed in claim 2, wherein the computer telephony speech module further sends the active message to the reset module, and if no active message or reset message is received in a second predefined time period, the reset module automatically performs a reset operation, where the second predefined time period is larger than the first predefined time period.

4. The system as claimed in claim 1, wherein each of the first and second communication interfaces is a network card so that the detecting unit and the computer telephony speech server unit are connected through a network.

5. The system as claimed in claim 1, wherein each of the first and second communication interface is an RS232 interface for connecting the detecting unit to the computer telephony speech server unit.

6. The system as claimed in claim 2, wherein each of the first and second communication interfaces is a network card so that the detecting unit and the computer telephony speech server unit are connected through a network.

7. The system as claimed in claim 2, wherein each of the first and second communication interface is an RS232 interface for connecting the detecting unit to the computer telephony speech server unit.

8. The system as claimed in claim 3, wherein each of the first and second communication interfaces is a network card so that the detecting unit and the computer telephony speech server unit are connected through a network.

9. The system as claimed in claim 3, wherein each of the first and second communication interface is an RS232 interface for connecting the detecting unit to the computer telephony speech server unit.

10. The system as claimed in claim 1, wherein the computer telephony speech server unit is a computer device capable of providing a telephone speech service.

11. The system as claimed in claim 1, wherein the detecting unit is implemented by a computer device.

12. A method for detecting crash and automatically resetting a computer telephony speech system, the computer telephony speech system including a computer telephony speech server unit and a detecting unit for connecting to the computer telephony speech server unit, the computer telephony speech server unit having a reset module for performing a reset operation; the method comprising the steps of:
(A) when correctly answering a call, the computer telephony speech server unit issuing an active message for being sent to the detecting unit through a communication link; and
(B) if no active message is received in a first predefined time period, the detecting unit issuing a reset message to the reset module of the computer telephony speech server unit for performing a reset operation.

13. The method as claimed in claim 12, wherein, in step (B), if no active message is received in the first predefined time period, the detecting unit dials a call to the computer telephony speech server unit, and if the computer telephony speech server unit can not answer the call, the detecting unit sends a reset message to the reset module of the computer telephony speech server unit through a communication link for performing a reset operation.

14. The method as claimed in claim 13, wherein, in step (A), the active message is also sent to the reset module.

15. The method as claimed in claim 14, further comprising a step (C) for automatically performing a reset operation if the reset module does not receive any active message or reset message in second predefined time period, wherein the second predefined time period is larger than the first predefined time period.
